(19) United States
(12) Patent Application Publication
(10) Pub. No.: US 2005/0260390 A1
(43) Pub. Date: Nov. 24, 2005

(54) Coated substrate

(76) Inventors: Steven A. Croft, Grandville, MI (US); Edward W. Burmeister, Nunica, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/038,438

(22) Filed: Jan. 19, 2005

Related U.S. Application Data
(60) Provisional application No. 60/537,210, filed on Jan. 19, 2004.

(51) Int. Cl. B32B 5/02; B32B 27/04; B32B 3/00

(52) U.S. Cl. 428/196; 428/195.1; 442/121; 442/123; 442/136

(57) ABSTRACT

According to one embodiment, a coated substrate comprises a pliable substrate and a plurality of dots disposed on a surface of the substrate. The dots may have any one or more of the following characteristics: (1) a substantially conical profile to provide enhanced texturing; (2) a height of between about 5.5 to 8 mils; and (3) act as a carrier for fragrants, insect/pest repellant or attractant, micro biocide, fire retardant, cleaning chemical, furniture wax, polish, or any material that is to be time-released. The dots may be disposed on the substrate in a non-uniform pattern. The pattern may include text and/or logo and brand names. Such a logo or brand name formed of such dots may thus serve a function due to its texture.

### CROSS-REFERENCE TO RELATED APPLICATION

This application claims priority under 35 U.S.C. 119(e) to U.S. Provisional Patent Application No. 60/537,210, entitled “COATED SUBSTRATE,” filed on Jan. 19, 2004, the entire disclosure of which is incorporated by reference.

### BACKGROUND OF THE INVENTION

The present invention generally relates to coated substrates, particularly to those used for wiping.

Wipes used for industrial, household, and personal cleaning come in a wide variety of configurations. These wipes may be packaged as separated sheets, perforated sheets on a roll, or with a handle or extension for use in a brush or mop. Although the market for such wipes is very lucrative, there have been relatively few improvements in wipes in many years.

The assignee of the present application recently developed an exfoliating pad which included a non-woven fabric 1 on which a plurality of dots 5 were printed onto one surface of fabric 1. The non-woven fabric is made of hydroentangled fibers. These dots were made of ethylenevinylacetate (EVA) and were printed uniformly across the entire surface of the fabric sheet 1 as illustrated in FIG. 1. The dots 5 were generally circular in shape as depicted in FIG. 2, which is a close-up view of the sheet shown in FIG. 1. Dots 5 were white in color as was fabric 1. As best shown in FIG. 3, which is a cross-section of a portion of the sheet shown in FIG. 2, the dots 5 project upward from the surface of the fabric 1 to a height A and have a semi-spherical profile as shown in FIG. 3. This height A ranged from 3.5 to 8 mils. Dots 5 were provided simply for texture to improve the exfoliating functionality of the exfoliating pad.

FIG. 4 illustrates an apparatus 10 used to print the dots 5 on the fabric 1. As shown, the apparatus includes a basin 12 containing the EVA material 14 in hot melt form. A pick-up cylinder 16 rotates partially through the hot melt material 14 and thereby picks up the hot melt material 14 on its outer surface. A transfer cylinder 18 is provided in contact with pick-up cylinder 16 for transferring the hot melt material onto the web of fabric 1. The transfer cylinder 18 includes a plurality of small indentations in which the hot melt material 14 is retained after the transfer cylinder 18 rotates past a scraper blade 20. A scraper blade 20 scrapes off all of the hot melt material 14 except for that remaining in the indentations 19 on transfer cylinder 18. A pressure application cylinder 22 is provided on the opposite side of the web of fabric 1 so as to push the fabric against the scraped surface of transfer cylinder 18. As the web of fabric 1 passes between cylinders 18 and 22, small dots of the hot melt material 14 are deposited on the web of fabric 1. A cutter or perforator is then provided downstream to perforate or cut the coated web of fabric 1 into perforated or separated sheets.

Although the above-described exfoliating pad works very well for exfoliation, it is not ideally suited for many other applications. For example, the EVA material forming the dots is not sufficiently biodegradable to be flushed into a septic or sewer system and also is not sufficiently resistant to hydrocarbon solvents as are used in many cleaning solutions.

### SUMMARY OF THE INVENTION

According to one embodiment of the present invention, a coated substrate for use as a wipe is provided that comprises a pliable substrate and a plurality of dots disposed on a surface of the substrate, where the dots are distributed non-uniformly across the surface of the substrate. The non-uniform distribution of the dots may result in the coated substrate having at least one region of a size of at least 1 cm² that has no dots, while other regions of at least 1 cm² on the same surface have dots.

According to another aspect of the present invention, a coated substrate for use as a wipe is provided that comprises a pliable substrate and a plurality of dots disposed on a surface of the substrate, where at least some of the dots are provided in a pattern so as to create brand identification information. The pattern may define text and/or logo and brand names. Such a logo or brand name formed of such dots may thus serve a function due to its texture.

According to another aspect of the present invention, a coated substrate for use as a wipe is provided that comprises a pliable substrate and a plurality of dots disposed on a surface of the substrate, wherein the dots have a generally conical profile.

According to another aspect of the present invention, a coated substrate for use as a wipe is provided that comprises a pliable substrate and a plurality of dots disposed on a surface of the substrate, wherein the dots are comprised of a polymer and a second material for performing at least one secondary function.

According to another aspect of the present invention, a method for manufacturing a dot-coated pliable substrate comprises: providing a transfer cylinder having a plurality of indentations for delivering dots of polymer material; providing an impression cylinder carrying a relief pattern on its outer surface; supplying polymer material to the transfer cylinder; and feeding a pliable substrate between the impression cylinder and the transfer cylinder such that the relief pattern is pressed against one surface of the pliable substrate to cause polymer dots to selectively attach to regions on the opposite surface of the pliable substrate.

According to another aspect of the present invention, an apparatus is provided for manufacturing a dot-coated pliable substrate. The apparatus comprises a transfer cylinder having a plurality of indentations for delivering dots of polymer material and an impression cylinder carrying a relief pattern on its outer surface, wherein a pliable substrate is fed between the impression cylinder and the transfer cylinder such that the relief pattern is pressed against one surface of the substrate to cause polymer dots to selectively attach to the opposite surface of the pliable substrate.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1 is a perspective view of one sheet of a conventional exfoliating wipe;

FIG. 2 is a close-up perspective view of the region identified as region II shown in FIG. 1;

FIG. 3 is a cross-sectional view taken along line III-III of the exfoliating wipe shown in FIG. 2;

FIG. 4 is a perspective view of an apparatus used to create the conventional exfoliating wipe shown in FIGS. 1-3;

FIG. 5 is a perspective view of a wipe constructed in accordance with one embodiment of the present invention;

FIG. 6 is a close-up perspective view of the region of the wipe identified as region VI shown in FIG. 5;

FIG. 7 is a cross-sectional view taken along line VII-VII of the wipe shown in FIG. 6;

FIG. 8 is a perspective view of an apparatus that may be used to manufacture a wipe in accordance with the present invention;

FIG. 9 is an end view schematic representation of the apparatus shown in FIG. 8;

FIG. 10 is a close-up perspective view of region X of the transfer cylinder of the apparatus shown in FIG. 8;

FIG. 11 is a cross-sectional view of a portion of the flexographic plate taken along line XI-XI in FIG. 8;

FIG. 12 is a perspective view of a wipe constructed in accordance with another embodiment of the present invention;

FIG. 13 is a close-up perspective view of the region of the wipe identified as region XIII shown in FIG. 12;

FIG. 14 is a cross-sectional view taken along line XIV-XIV of the wipe shown in FIG. 13;

FIG. 15 is a perspective view of an apparatus that may be used to manufacture a wipe shown in FIGS. 12-14 in accordance with the present invention; and

FIG. 16 is a close-up perspective view of region XVI of the transfer cylinder of the apparatus shown in FIG. 15.

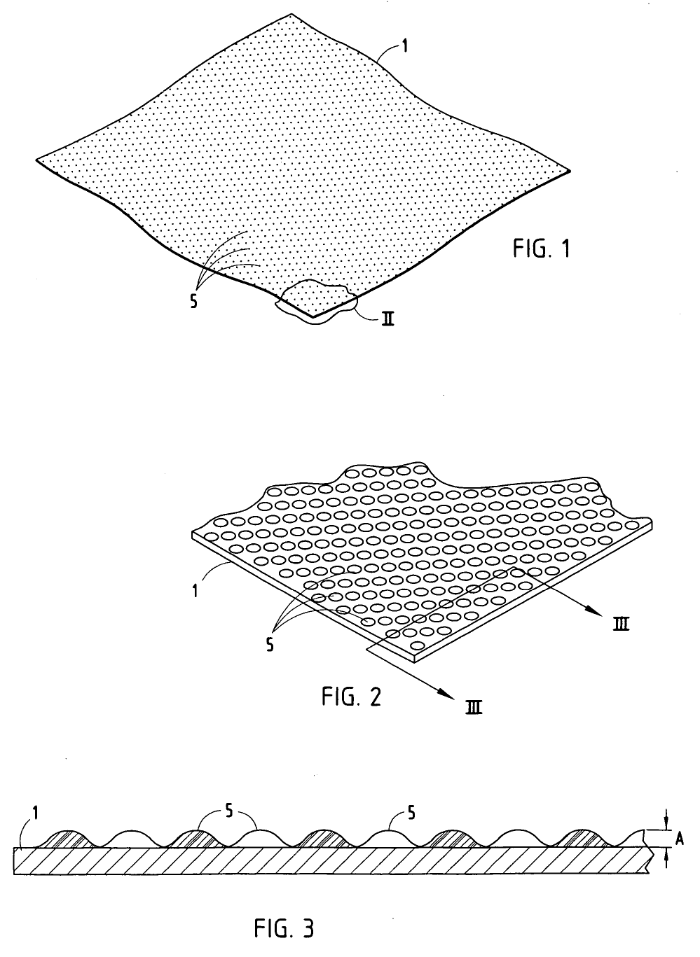

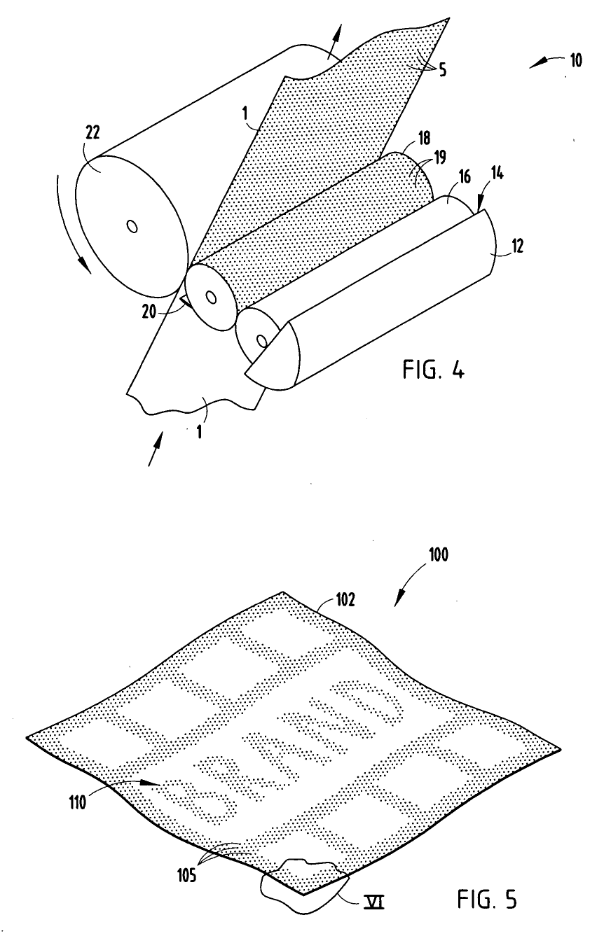

### DETAILED DESCRIPTION

The treated product 100 of the present invention comprises a pliable substrate 102 having a surface on which many dots 105 are deposited. As shown in FIG. 5, dots 105 may be deposited in a non-random, non-uniform manner so as to define a design or pattern that may include brand identification information including one or more brand names/logos 110 formed from the printed dots 105. As will be apparent to those skilled in the art, various other logos, pictures, written words, letters, or numbers may likewise be formed by the appropriate distribution of dots 105 on substrate 102.

Pliable substrate 102 may be formed of a non-woven fabric or other material including non-woven materials that are air-laid, carded, spunbonded, meltblown, wetlaid, or spunlaced. In addition, the substrate 102 may be formed of a fibrous material where the non-woven fibers may be made of polyester, polyamide, polypropylene, acrylic, polyethylene, viscose rayon, cotton, acetate, carbon, super absorbent polymer (SAP), or bicomponent. Such fibers may be held together by means of needle punching, hydroentangling, resonating, embossing, calendaring, thermo-bonding, using powders or bicomponent fibers, or point-bonding.

Another possible material that may be used for substrate 102 is foam, which may be made of polyurethane, polyether, or polyester. In addition, substrate 102 may be formed of woven material such as cloth, or of laminations of any of the above materials.

The specific material selected for substrate 102 depends largely upon the particular application for which the product is to be used. For example, for certain household cleaning applications, the substrate may need to be made of a biodegradable material such that it may be disposed by flushing down a toilet whether the toilet is coupled to a sewer system or septic system. Additional characteristics that may be required are high absorbance and/or strength. Again, the selection of the appropriate substrate material depends upon the particular application for which the product is to be used. Additional examples of particular substrates are discussed further below.

The dots may be formed of a variety of materials including: polyethylene; polyester; polyamide (nylon); ethylene-acrylic acid copolymers (EAA); ethylene/n-butyl acrylate copolymers (EnBA); polyurethane; ethylene-vinyl alcohol (EVOH); polyvinyl alcohol (PVOH); ethylenevinylacetate (EVA); polyvinylacetate (PVA); rubber; wax; polypropylene; and poly(lactic acid) (PLA). Other materials may additionally be suitable as well as various combinations of the above materials. The dots may be made of a biodegradable material. The particular materials selected for the dots, as well as the size, shape and height of the dots and the pattern in which they are applied to the substrate 102, depends in large part upon the function to be served by the dots. The various functions of such dots are described further below.

Dots 105 can be provided on substrate 102 to provide texture. The morphology of the dot shapes can be optimized to yield a specific level of texture that meets a task requirement of a specific wipe application. One dot shape that can be used is roughly conical. The sharpness of the point on the cone can be controlled through a range from nearly hemispherical to a sharp point and may include an extension from the top of the cone similar to the “curly Q” produced on the top of an ice cream cone to further enhance texture. Such texture may be used to improve the ability to scrub when used for cleaning purposes. In addition, the texture may provide additional grip by creating a non-skid surface. The dot material can also be deposited in other patterns such as a grid or honeycomb to meet specific design requirements of a final product.

Texture can also be modified by changing the spacing between dots in an overall coated pattern. Additionally, texture can be modified by coating a pattern of shapes (e.g., stripes) interspersed with areas that are uncoated. Use of these methods has the additional benefits of providing uncoated areas to facilitate transfer of a solution (e.g., cleaning solution) from a wet wipe to the surface being cleaned without being blocked by the polymer shapes, as well as providing exposed areas of non-woven substrate to allow the non-woven substrate to wipe up/absorb any material that has been loosened by the scrubbing action of the polymer shapes.

Another benefit of these methods of depositing dots or other shapes onto non-woven substrate is that the original drapeability (“hand”) of the non-woven substrate is not significantly changed.

The material used to form the dots 105 may also act as a carrier for other materials such as a fragrant, a micro-biocide, an insect/pest repellent/attractant, a color pigment, or a file retardant. In addition, the material forming the dots 105 may act as a carrier for various functional products such as a cleaning chemical, a furniture wax, or a polish. In addition, the material forming dots 105 may act as a carrier for a material that needs to be time-released and can escape from the dot material due to the material breaking down or dissolving with exposure to moisture, light, or heat.

An additional function of dots 105 is that the dots may be printed in the form of text for brand name or trademark communication. Thus, not only do the dots provide this brand name or trademark communication, but the printed text itself may be functional by acting as a carrier or providing texture.

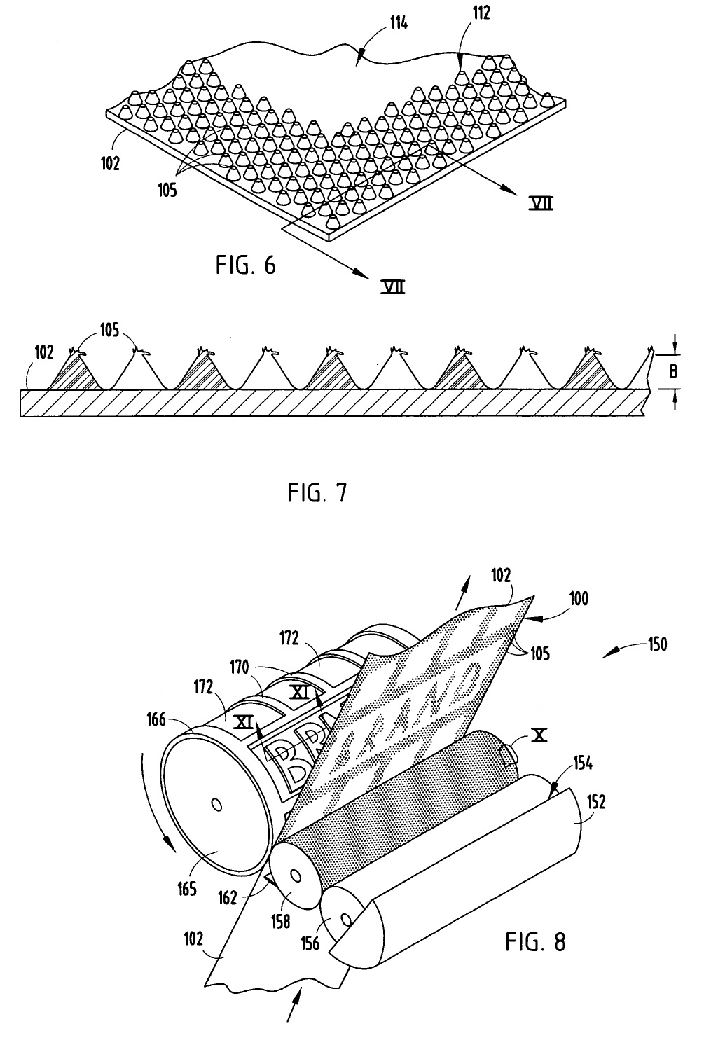

As shown in FIGS. 5 and 6, the dots may be applied to substrate 102 in a non-uniform manner. If the dots include a color that is different from the substrate 102, the dots may be used to form patterns or text. The use of a non-uniform dot distribution has certain functional advantages as well insofar as it creates different functional regions on the product. For example, region 112 may include a high density of dots per square area and thus be used for scrubbing whereas area 114 may include few or no dots so as to be more absorbent. Thus, for example, to be “non-uniform,” one or more regions of a product may have an area as small as 1 cm² with a significantly higher density of dots than another region also having an area as small as 1 cm². In fact, a product may have several regions having an area of at least 1 cm² that are not covered by any dots whatsoever.

As shown in FIG. 7, which is a cross-section of the product shown in FIG. 6 taken along line VII-VII, dots 105 preferably have a height B which may range from about 5.5 to 8 mils.

An apparatus and method for making the product illustrated in FIGS. 5-7 is described below with reference to FIGS. 8-11. Apparatus 150 comprises a basin 152 in which the material 154 from which the dots are made is provided. Preferably, this material is heated to form a hot melt of the material that may be picked up by a pick-up cylinder 156, which is rotated partially within basin 152 within the hot melt material 154 so as to pick up a uniform coating of the hot melt material on its outer surface. A transfer cylinder 158 is provided to rotate in contact with the hot melt adhesive on pick-up cylinder 156. Transfer cylinder 158 includes a plurality of indentations 160 as best shown in FIG. 10. These indentations are sized, shaped and dispersed across the entire surface of transfer cylinder 158 to correspond to the size and shape of the dots 105 that are applied to substrate 102. A wiper blade 162 is provided to scrape off the excess hot melt material from the surface of transfer cylinder 158 with the exception of hot melt adhesive that is within indentations 160. Wiper blade 162 is preferably positioned over the basin 152 such that the scraped hot melt material 154 drops back within basin 152. A stirring mechanism (not shown) may be provided in basin 152 to keep the hot melt material 154 uniformly heated and viscous.

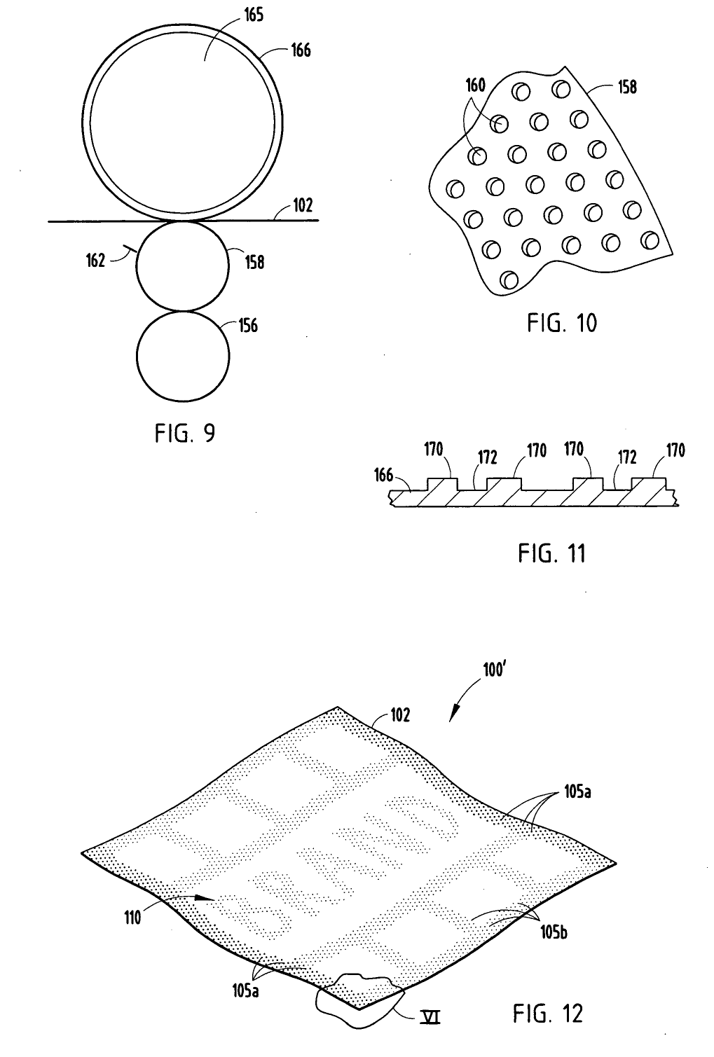

Apparatus 150 further includes an impression cylinder 165 that is rotated and pressed against transfer cylinder 158. As best shown in FIGS. 8 and 9, a continuous web of substrate 102 is fed between cylinders 158 and 165 such that impression cylinder 165 presses a flexographic (i.e., a photopolymer) plate 166 against the substrate 102 and against selective regions of transfer cylinder 158. Flexographic plate 166 is secured about the outer surface of impression cylinder 165. FIG. 11 is a cross-sectional view of a portion of flexographic plate 166. As shown, the outer surface 168 that is pressed against the substrate 102 includes protruding surfaces 170 and recessed surfaces 172. The recessed surfaces 172 do not provide adequate pressure against substrate 102 to cause the hot melt material 154 in the indentations 160 on transfer cylinder 158 to transfer onto substrate 102. The protruding surfaces 170, however, do provide sufficient pressure to cause the hot melt material 154 in the indentations 160 to transfer onto those select regions of the surface of substrate 102 opposite those with which the protruding surfaces 170 come into contact. The transfer of the hot melt material 154 onto those regions of substrate 102 thus produces the dots 105 discussed above in the pattern corresponding to the relief pattern on flexographic plate 166.

The size, shape and spacing of dots 105 may be varied by changing the size, shape, and spacing of the indentations 160 on transfer cylinder 158. Likewise, the pattern formed by the dots on substrate 102 may be varied by varying the relief pattern of the flexographic plate 166. With such flexibility, virtually any design is possible.

To verify the effectiveness and reproducibility of the present invention, the following example is described. The example described below is intended to be but one example of the present invention and is not intended to limit the invention in any way.

### EXAMPLE

A polyester hot melt was prepared and supplied in a basin of an apparatus such as that shown in FIG. 8. The substrate was formed of a mixture of hydroentangled polypropylene and viscose rayon fibers. The dots had substantially conical profiles. A number of different patterns were printed using flexgraphic plates with different relief patterns. Some of the patterns included text in the form of a logo, as well as stripes and cross-hatching. The resultant products exhibited excellent adhesion of the dots to only those regions of the substrate where they were meant to adhere with no dot adherence where the dots were not intended to adhere to the substrate. The polyester dots were also formed on various other substrates made of conventional wipe materials with equal success.

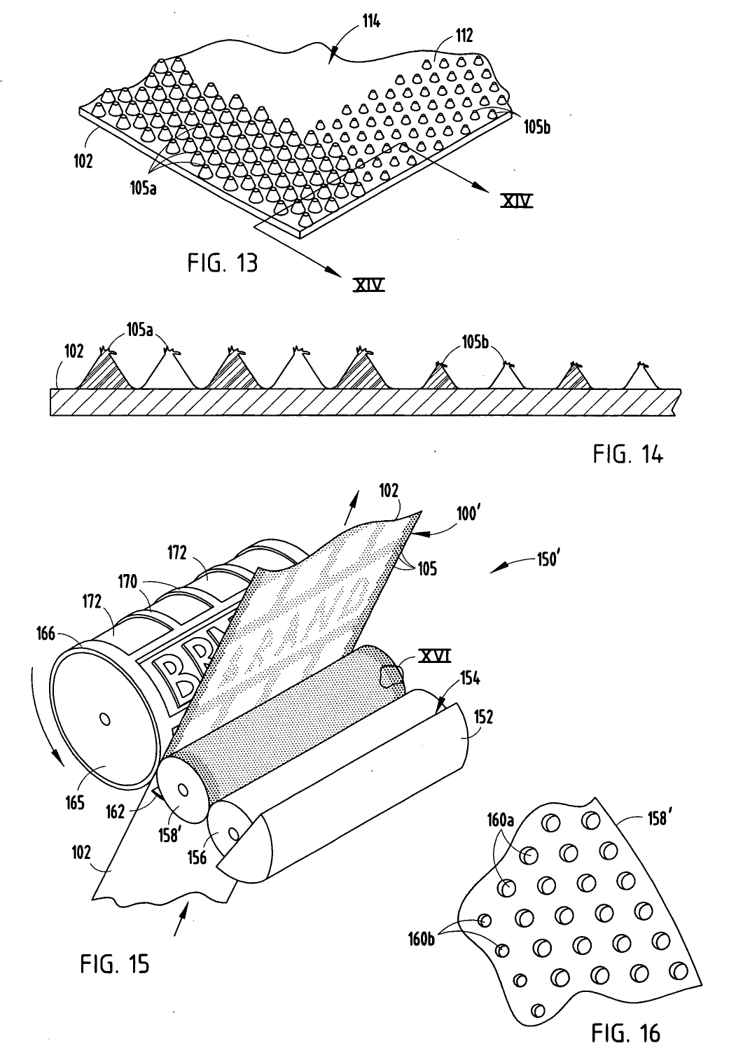

FIGS. 12-14 show a wipe 100′ constructed in accordance with a second embodiment of the present invention. Wipe 100′ differs from wipe 100 shown in FIGS. 5-7 in that a portion of the dots (105a) are larger than the other dots (105b). This allows for different regions of wipe 100′ to be used for different functions. For example, the finer sized dots 105b may be employed primarily for brand identification or decorative patterning while larger dots 105a may be employed to provide for greater scrubbing functionality. The finer dots 105b could also include a time-release detergent or the like.

FIGS. 15 and 16 show an apparatus 150′ for manufacturing coated substrate 100′.

Apparatus 150′ differs from apparatus 150 shown in FIGS. 8-11 in that transfer cylinder 158′ includes indentations 160a and 160b that are of different size and/or depth to thereby create dots 105a and 105b, respectively, of different sizes. It should be appreciated that rather than using a single transfer cylinder 158′ having different sized indentations 160a and 160b, separate transfer cylinders could be used by coaxially mounting the cylinders on a common axis. In this case, each separate transfer cylinder would have indentations of uniform size, and yet the size of the indentations would vary from cylinder to cylinder. If separate transfer cylinders are used, the cylinders could be slightly axially spaced from one another and basin 152 could have separate compartments for each separate transfer cylinder to allow different materials to be applied to different regions of the substrate. The different materials may differ only in color, or may alternatively or additionally differ in other characteristics.

The coated substrates of the present invention may be used for a wide variety of applications. Such applications include as personal cleaning wipes, household cleaning wipes, and industrial wipes. In addition, the coated substrates may be configured and used as placemats or tablecloths. Such placemats or tablecloths could be constructed of conventional substrate materials, but with dots formed thereon that provide a skid resistant surface. The dots on the placemats or tablecloths may also function as carriers for insect repellants such as citronella or mint fragrants.

Although the coated substrates are described above for specific uses, it will be appreciated by those skilled in the art that the coated substrates of the present invention may be used for other applications and that the present invention is not limited to the applications described herein.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

1. A coated substrate for use as a wipe, comprising:
a pliable substrate; and
a plurality of dots disposed on a surface of said substrate, wherein said dots are distributed non-uniformly across the surface of said substrate.

2. The coated substrate of claim 1, wherein a number of said dots are provided within one square centimeter of the surface of said substrate, and wherein at least one region of at least one square centimeter of the surface of said substrate does not include any of said dots.

3. The coated substrate of claim 1, wherein a number of said dots are provided in a pattern so as to create a logo.

4. The coated substrate of claim 1, wherein a number of said dots are provided in a pattern so as to create a word.

5. The coated substrate of claim 1, wherein a number of said dots are provided in a pattern so as to create a brand name.

6. The coated substrate of claim 1, wherein said substrate is made of a non-woven material.

7. The coated substrate of claim 6, wherein said substrate comprises a non-woven material.

8. The coated substrate of claim 7, wherein said substrate is formed of a fibrous material comprising non-woven fibers.

9. The coated substrate of claim 8, wherein said non-woven fibers are made of a material selected from the group consisting of polyester, polyamide, polypropylene, acrylic, polyethylene, viscose rayon, cotton, acetate, carbon, super-absorbent polymer, and bicomponent.

10. The coated substrate of claim 9, wherein said non-woven fibers are held together by means of one of the following: needle-punching, hydroentangling, resonating, embossing, calendaring, thermo-bonding using powders or bicomponent fibers, and point-bonded.

11. The coated substrate of claim 1, wherein said substrate is a foam.

12. The coated substrate of claim 11, wherein said foam is made of a material selected from the group consisting of polyurethane, polyether, and polyester.

13. The coated substrate of claim 1, wherein said substrate is made of a woven material.

14. The coated substrate of claim 13, wherein said woven material is a cloth.

15. The coated substrate of claim 1, wherein said substrate is made of a biodegradable material.

16. The coated substrate of claim 1, wherein said dots are made of a polymeric material.

17. The coated substrate of claim 16, wherein said polymeric material is selected from the group consisting of: polyethylene; polyester; polyamide; ethylene-acrylic acid copolymers; ethylene/n-butyl acrylate copolymers; polyurethane; ethylene-vinyl alcohol; polyvinyl alcohol; ethylenevinylacetate; polyvinylacetate; rubber; wax; polypropylene; and poly(lactic acid).

18. The coated substrate of claim 1, wherein said dots have a generally conical profile.

19. The coated substrate of claim 1, wherein said dots have a height of between about 5.5 to 8 mils.

20. A coated substrate for use as a wipe, comprising:
a pliable substrate; and
a plurality of dots disposed on a surface of said substrate, wherein at least some of said dots are provided in a pattern so as to create brand identification information.

21. The coated substrate of claim 20, wherein said brand identification information includes a logo.

22. The coated substrate of claim 20, wherein said brand identification information includes a brand name.

23. The coated substrate of claim 20, wherein said dots are distributed non-uniformly across the surface of said substrate

24. The coated substrate of claim 20, wherein said dots have a height of between about 5.5 to 8 mils.

25. The coated substrate of claim 20, wherein said dots have a generally conical profile.

26. A method for manufacturing a dot-coated pliable substrate, the method comprising:
providing a transfer cylinder having a plurality of indentations for delivering dots of polymer material;
providing an impression cylinder carrying a relief pattern on its outer surface;
supplying polymer material to the transfer cylinder; and
feeding a pliable substrate between the impression cylinder and the transfer cylinder such that the relief pattern is pressed against one surface of the pliable substrate to cause polymer dots to selectively attach to regions on the opposite surface of the pliable substrate.

27. An apparatus for manufacturing a dot-coated pliable substrate, the apparatus comprising:
a transfer cylinder having a plurality of indentations for delivering dots of polymer material; and
an impression cylinder carrying a relief pattern on its outer surface,
wherein a pliable substrate is fed between said impression cylinder and said transfer cylinder such that said relief pattern is pressed against one surface of the pliable substrate to cause polymer dots to selectively attach to regions on the opposite surface of the pliable substrate.

28. The apparatus of claim 27 and further comprising a pick-up cylinder for picking up the polymer material and supplying the polymer material to said transfer cylinder.

29. A coated substrate for use as a wipe, comprising:
a pliable substrate; and
a plurality of dots disposed on a surface of said substrate, wherein said dots have a generally conical profile.

30. The coated substrate of claim 29, wherein said dots have a height of between about 5.5 to 8 mils.

31. The coated substrate of claim 29, wherein said dots are distributed non-uniformly across the surface of said substrate

32. A coated substrate for use as a wipe, comprising:
a pliable substrate; and
a plurality of dots disposed on a surface of said substrate, wherein said dots are comprised of a polymer and a second material for performing at least one secondary function.

33. The coated substrate of claim 32, wherein said second material is selected from the group consisting of a fragrant, an insect/pest repellant/attractant, a micro biocide, a fire retardant, a cleaning chemical, a furniture wax, and a polish.

34. The coated substrate of claim 32, wherein said second material is material that is to be time-released.

35. The coated substrate of claim 32, wherein at least some of said dots are of a different size than other dots.

36. The coated substrate of claim 32, wherein said dots are distributed non-uniformly across the surface of said substrate
